(19) United States
(12) Patent Application Publication
(10) Pub. No.: US 2009/0175211 A1
(43) Pub. Date: Jul. 9, 2009

(54) METHOD AND SYSTEM FOR COMMUNICATION

(75) Inventor: Jens Jakobsen, Malmo (DK)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/301,026

(22) PCT Filed: Apr. 17, 2007
(86) PCT No.: PCT/US07/66745

§ 371 Date: Nov. 15, 2008

(30) Foreign Application Priority Data
May 26, 2006 (GB) 0610405.3

(51) Int. Cl. H04H 20/71

(52) U.S. Cl. 370/312

(57) ABSTRACT

A method (200) of operation in a communication system (100) including a plurality of hosts (105, 115, 125) a controller (133) operable to allocate resources for communications to be sent between hosts in the system, and a network of routers (102, 112, 122) operable to route communications between the hosts by multicast transmission, the method including the controller sending (213) to target routers associated with target hosts which are to receive a communication from a sending host a prompt message prompting the target routers to form a multicast tree via which the communication is to be deliverable.

### FIELD OF THE INVENTION

The present invention relates to a method and system for communication. In particular, the invention relates to communication using multicast transmissions which may be in accordance with Internet Protocol compatible procedures. The system may be a wireless communication system such as a mobile communication system.

### BACKGROUND OF THE INVENTION

Wireless communication systems, for example cellular telephony or private mobile radio communication systems, typically provide for radio communication links to be arranged within the system between a plurality of user terminals. Such user terminals may be mobile and may therefore be known as ‘mobile stations’ or ‘MSs’. Such a system typically includes a system infrastructure which generally includes a network of various fixed installations such as base stations or ‘BSs’ which are in direct radio communication with user terminals and routers which route communications in the network between base stations. Each of the BSs operating in the system may have one or more transceivers which may for example serve MSs in a given local region or area, known as a ‘cell’ or ‘site’, by radio communication. Such a system is known as a cellular system. The MSs which are in direct communication with a particular BS are said to be served by the BS, and all radio communications to or from each MS within the system are made via its serving BS. Cells of neighbouring BSs in a cellular system are often overlapping.

Wireless communication systems typically operate according to a set of industry standard wireless communication procedures or protocols known collectively as a ‘standard’. An example of such a standard is the TETRA (TErrestrial Trunked Radio) standard which has been defined by the European Telecommunications Standards Institute (ETSI). A system which operates according to the TETRA standard is known as a TETRA system. TETRA systems are primarily designed for application by professional radio users such as the emergency and security services. Other systems designed for application by such professional radio users include APCO 25 systems which operate in accordance with the APCO Project 25 standard defined by the Association of Public-Safety Communications Officials International, Inc.

In wireless communication systems such as TETRA systems, communications may be sent on different channel types according to the type of signalling to be sent. For example, control signals for system synchronisation and control are sent on a control channel. Signals to communicate user speech and data are sent respectively on a voice channel and a data channel. User speech and data is known collectively as traffic information.

Some wireless communication systems are being designed to employ procedures which operate in accordance with Internet Protocol (IP) compatible standards to manage communications within the system. For example, some TETRA systems are being designed in this way. In such systems, communicated traffic information is sent in the form of IP compatible data packets between user terminals by use of IP addresses. Unicast (point-to-point) IP addressing may be used where only a single target terminal is to receive a communication sent via the system from a single sending terminal. Multicast (point-to-multipoint) IP addressing may be used where more than one target terminal has to receive communicated information from a sending terminal. Target terminals are generally user terminals or base stations serving user terminals. In addition, one of the target terminals may be a dispatcher terminal used for receiving and sending messages relating to operation of the organisation, e.g. police, in which the communication system is used. Alternatively, or in addition, one of the target terminals may comprise a recorder to record traffic information being communicated. Alternatively, or in addition, the system may include telephony gateways and gateways to other communication systems. Generally, user terminals and the BSs that serve them are known as hosts, i.e. stations or nodes that can take part in two way communication with other hosts. Communications between hosts are delivered by routers of the system arranged in a network.

In multicast IP addressing, a common IP multicast address is used to define a multicast group of target hosts and a communication tree to the target hosts via routers of the communication system. An originating router of the system is associated with a sending host, e.g. a sending MS via its serving BS or a sending BS serving a sending MS. Target routers of the system are associated with target hosts, e.g. target user terminals via their serving BSs or target BSs serving target user terminals. A multicast tree required for multicast delivery of a communication from the sending host to the target hosts is established by a network of routers. The originating router delivers the communication to the target routers via the multicast tree established between routers of the network. Use of multicast delivery in this way for group communications is beneficial to maintain good system bandwidth efficiency since only sites at which group members are attached need to receive group communications.

In communication systems which operate using multicast IP addressing, a management server or controller, which may be one of a plurality of such servers, may allocate resources for communications to be sent in the system, e.g. access to wireless channels of the system via which traffic information may be sent by wireless communication. In TETRA systems, such a server is known as a zone controller. Where sending of a wireless communication from a sending host to a plurality of target hosts is requested by the sending host, the management server allocates channel resource for the communication and sends a call grant message to the sending and target hosts indicating the channel resource allocated for the communication. Each host, e.g. each BS, receiving the call grant message as a target host may in response send a message, e.g. an IP compatible standard message, to an associated (target) router indicating that the router should join a multicast tree to receive the communication on behalf of that host. The associated router may then send to the network of routers a join response message, e.g. an IP compatible standard message, indicating that the associated router requires to join a multicast tree to receive the communication. Each join response message is used by the routers of the network to establish the required multicast tree. The communication from the sending host to the target hosts is then sent via the established multicast tree.

Traffic information may be communicated by a sending host which is a sending user terminal served by a BS as soon as the management server has allocated the appropriate channel resource and has sent a suitable call grant message back to the sending terminal via its serving BS. Where the traffic information to be communicated is speech, the user of the sending terminal may begin speaking after receipt of the call grant message by the sending terminal. A delay, e.g. of about 200 milliseconds, may be applied by the management server before sending the call grant message to the sending terminal. However, all of the target hosts required to join the multicast group to receive the communication may not have joined the group when the traffic information transmission begins, because the multicast tree has still not been established. Thus, there can be an undesirable loss of traffic information received at target receiving hosts, e.g. user terminals, during the period taken to establish the communication group via a multicast tree. This loss could be very serious in certain critical user operations of the system. The loss can become pronounced particularly where a target user terminal or its serving BS has a satellite link to the other components of the system infrastructure, e.g. to the associated router. Such links can result in a typical delay of about 600 milliseconds (about 300 milliseconds each way) which contributes significantly to the time required to establish the IP multicast tree.

### SUMMARY OF THE INVENTION

According to the present invention in a first aspect there is provided a method of operation in a communication system, the method being as defined in claim 1 of the accompanying claims.

According to the present invention in a second aspect there is provided a communication system as defined in claim 19 of the accompanying claims.

Further features of the invention are as disclosed in the embodiments of the invention to be described.

Embodiments of the present invention will now be described by way of example with reference to the accompanying drawings, in which:

### BRIEF DESCRIPTION OF THE ACCOMPANYING DRAWINGS

FIG. 1 is a block schematic diagram of an illustrative communication system adapted in accordance with an embodiment of the invention.

FIG. 2 is a flow chart of a method of operation embodying the invention in the system of FIG. 1.

### DESCRIPTION OF EMBODIMENTS OF THE INVENTION

According to embodiments of the invention to be described, there is a provided a method of operation in a communication system including a plurality of hosts, which are nodes or terminals of the system which are able to participate in two-way communication with other hosts. The system also includes a controller operable to allocate resources for communications to be sent between hosts in the system, and a network of routers operable to route communications between the hosts by multicast transmission. The method includes the controller sending to target routers associated with target hosts which are to receive a communication from a sending host a prompt message prompting the target routers to form a multicast tree via which the communication is to be deliverable.

At least one of the hosts may comprise a base station serving a plurality of user terminals by wireless communication.

The sending host may comprise a sending base station which is to send a communication on behalf of a sending user terminal served by the base station. The target hosts may comprise target base stations each operable to receive the communication and to deliver the communication to at least one target user terminal served by the target base station.

The system may comprise a mobile communication system and the user terminals may comprise mobile stations. The controller may be operable to allocate wireless channel resources for communications between user terminals in the mobile communication system.

The prompt message prompts the target routers to form a multicast tree via which the communication is to be deliverable. Following receipt of the prompt message from the controller, each of the target routers may send in response a join response message to the network of routers to indicate that a multicast tree should be formed to allow the intended communication to be sent from an originating router associated with a sending host. The join response message may indicate that the target router sending the join response message requires to join a multicast tree to receive the communication. In response to receiving join messages from the target routers, the router network may establish, e.g. by use of a rendezvous point of the router network, a multicast tree from the originating router for delivery of the communication. The originating router may receive from the sending user terminal via its serving base station the communication to be delivered to the target terminals of the group and may deliver the communication via the multicast tree which has been established.

The method embodying the invention may conveniently use Internet Protocol (IP) compatible procedures. In particular, the prompt message and the join response message may be standard messages known in IP compatible procedures. Furthermore, the multicast tree which is set up in the system may be an IP multicast tree. The IP multicast tree may be addressed using an IP address recognised within the system. The communication may be delivered via the multicast tree as IP compatible multicast data packets.

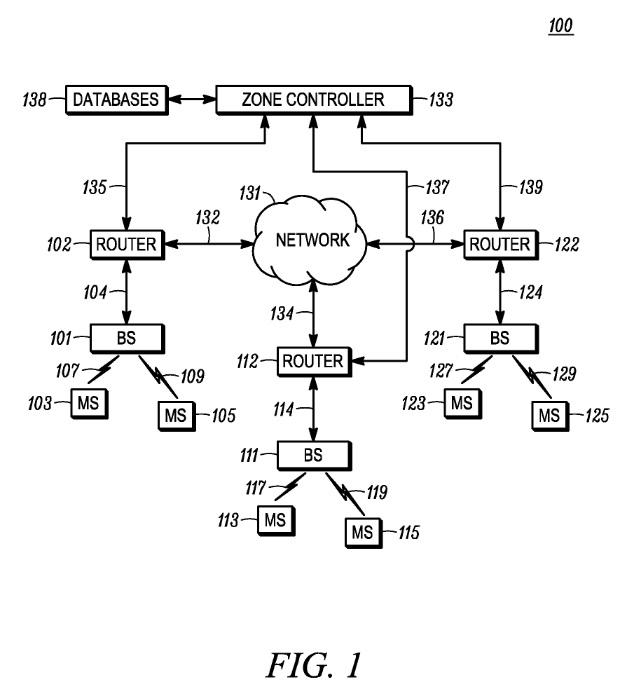

FIG. 1 is a block schematic diagram of a communication system 100 adapted in accordance with an embodiment of the invention. The system 100 is a communication system in which communication between hosts of the system 100 comprises wireless communication. The hosts comprise base stations, BSs, serving mobile stations, MSs. It will be apparent to those skilled in the art that the system 100 and the components which are to be described as operating therein, particularly the hosts therein, e.g. BSs, may take a number of forms. Thus, the form of the system 100, and of its operational components, to be described should be regarded as illustrative rather than limiting. The system 100 may be a TETRA or APCO 25 system although it could alternatively be a system operating according to another industry standard for communications, e.g. wireless communications, in which multicast transmissions are possible. The system 100 includes a BS (base station) 101 which provides radio communication service to user terminals in the form of MSs (mobile stations) within range of the BS 101, i.e. within a cell having the BS 101 at its centre. Two such MSs, namely an MS 103 and an MS 105, are shown having respectively radio links 107 and 109 to the BS 101. The system 100 also includes another BS 111 which provides radio communication service to user terminals in the form of MSs (mobile stations) within range of the BS 111, i.e. within a cell having the BS 111 at its centre. Two such MSs, namely an MS 113 and an MS 115, are shown having respectively radio links 117 and 119 to the BS 111. The system 100 also includes a BS 121 which provides radio communication service to user terminals in the form of MSs (mobile stations) within range of the BS 121, i.e. within a cell having the BS 121 at its centre. Two such MSs, namely an MS 123 and an MS 125, are shown having respectively radio links 127 and 129 to the BS 121.

The BS 101 is operationally associated via a link 104 with a router 102, e.g. a core router, which routes communications from the BS 101 (on behalf of MSs served by the BTS 101) to other terminals, e.g. MSs served by other BSs, within the system 100 and in other systems (not shown) operably connected to the system 100. The router 102 also routes incoming communications to the BS 101. The BS 111 is operationally associated via a link 114 with a router 112, e.g. a core router, which routes communications from the BS 111 (on behalf of MSs served by the BS 111) to other terminals, e.g. MSs served by other BSs, within the system 100 and in other systems operably connected to the system 100. The router 112 also routes incoming communications to the BS 111. The BS 121 is operationally associated via a link 124 with a router 122, e.g. a core router, which routes communications from the BS 121 (on behalf of MSs served by the BS 121) to other terminals, e.g. MSs served by other BSs, within the system 100 and in other systems operably connected to the system 100. The router 122 also routes incoming communications to the BS 121. The routers 102, 112 and 122 are operably connected via further links 132, 134 and 136 to a network 131 which may for example include a plurality of further routers and/or other nodes (not shown) which may include one or more telephony gateways and/or gateways to other communication systems. The routers 102, 112 and 122 are mutually connected to one another and to other routers (not shown) via the network 131. The links 104, 114, 124, 132, 134 and 136, and individual links (not shown) between nodes and/or routers (not shown) in the network 131, may comprise wired and/or wireless links. The routers 102, 112 and 122, together with any routers in the network 131, form a router network in the system 100. Although each of these routers is shown in FIG. 1 serving one associated BS, each router of the router network may serve each of a plurality of associated BSs, as will be apparent to those skilled in the art.

The system 100 includes a zone controller 133, which may be one of a plurality of zone controllers operating within the system 100. The zone controller 133 is a controller which comprises a management server or processor which controls allocation of communication channels within the system 100. The zone controller 133 has a link 135 to the router 102, a link 137 to the router 112 and a link 139 to the router 122. The links 135, 137 and 139 may be wired and/or wireless links. The links 135, 137 and 139 are shown as direct links but could optionally pass via the network 131. The zone controller 133 is also connected to databases 138 which hold details relating to composition of the system 100 including current locations of MSs and membership of groups of MSs within the system 100.

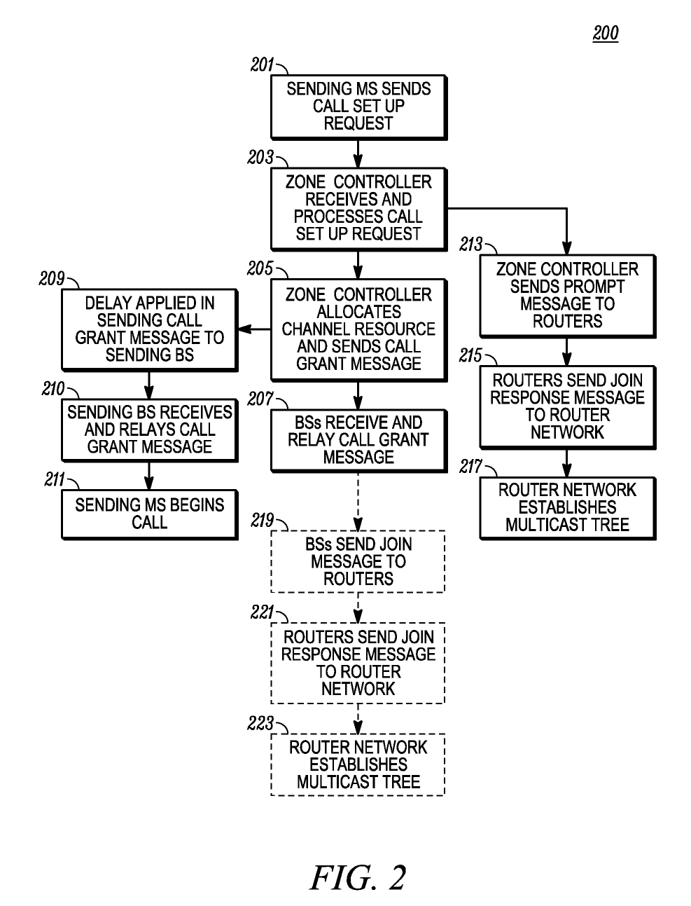

An illustrative method 200 of operation of the system 100 in accordance with an embodiment of the invention will now be described with reference to FIG. 2 which is a flow chart of the method 200. In the method 200, it is assumed that the MS 105 is to be a sending MS and is to send a communication to a plurality of other MSs including the MS 115 and the MS 125 which will be target receiving MSs. The sending MS 105 and the target receiving terminals including the MSs 115 and 125 are in a pre-defined group whose membership has previously been defined and recorded in the databases 138. The information to be communicated by the sending MS 105 may comprise speech information or data, e.g. a data stream representing alphanumeric text characters or picture or video data. The information to be communicated is herein referred to as ‘traffic information’ and the signal carrying such information is herein referred to as a ‘traffic signal’. The communication between the sending MS 105 and the target MSs 115 and 125 is referred to herein as a ‘call’ (even though the traffic information to be communicated may be other than speech information).

In a first step 201 of the method 200, a call set up request is sent by the sending MS 105, e.g. in response to a user operating a PTT (‘push to talk’) button (not shown) of the MS 105. The request sent by the MS 105 in step 201 identifies the group of target terminals including the MSs 115 and 125 which will participate in the requested call. The group may be identified by a group ID (identity) code previously allocated and recorded in the databases 138. The call set up request is received by the BS 101 via the radio link 109, and the BS 101 forwards the request via the link 104 to the router 102 which is to serve as an originating router on behalf of the sending MS 105 and its associated serving BS 101. The router 102 forwards the request via the link 135 to the zone controller 133. The zone controller 133 receives and processes the call set up request from the MS 105 in a step 203. In the processing of the request, the zone controller 133 retrieves from the databases 138 data relating to the group identified to participate in the call. The zone controller 133 thus becomes aware of the identity of target MSs that are members of the identified group. The zone controller 133 also determines in a known manner the identity of the BSs which are currently serving the target MSs. This determination may involve known steps (not shown in FIG. 2) in which the zone controller 133 sends a standard broadcast query signal to the target MSs (at a location assumed to be unknown) and the target MSs in response send back via their serving BS, or the serving BSs send on their behalf, a standard report signal to indicate the identity of the BS currently serving each target MS. The zone controller 133 thereby knows particular target BSs of the system that are to receive the intended call and signalling to establish it. The zone controller 133 also knows, e.g. from information relating to the fixed layout of the system 100 stored in the databases 138, the identity of the (core) routers serving the target BSs. These routers become target routers for signalling associated with set up of the call by the zone controller 133.

In a step 205 which follows step 203, the zone controller 133 allocates channel resource for the call and sends a call grant message indicating the channel resource which has been made available. The call grant message is sent to each target serving BS, via its associated target router, to which a target receiving MS is attached. Thus, the call grant message is sent to the router 112 via the link 137 and from the router 112 to the BS 111 via the link 114. Similarly, the call grant message is sent to the router 122 via the link 139 and from the router 122 to the BS 121 via the link 124. In a step 207, BSs serving target terminals, e.g. the BSs 111 and 121, receive the call grant message and relay the message to the appropriate target receiving terminal(s) served by them. Upon receiving the call grant message relayed in step 207, the target receiving terminals, e.g. the MSs that are to receive the call from the MS 105, including the MS 115 and the MS 125, prepare their receivers for receipt of traffic information in the call.

The call grant message is also sent from the zone controller 133 to the sending MS 105. However, in a step 209, the zone controller 133 applies a known delay before sending the call grant message for delivery to the sending MS 105. This known delay is applied so that target BSs are given time to join a multicast tree in a manner described later in relation to steps 219 to 223. The multicast tree is required to deliver traffic information in the call. The delay is applied for a selected period, e.g. about 200 milliseconds. The zone controller 133 does not have explicit knowledge that a multicast tree to the target BSs is in fact established by the time the delay period has expired. Obtaining explicit knowledge of establishment of the multicast tree would however significantly increase the call set up time, so it is assumed in the selection of the delay applied in step 209 that the required multicast tree can be established quickly enough to be ready when the delay period applied is completed. This assumption is false when a long delay link, e.g. a satellite wireless link, to one or more of the target BSs is used. However, fixing the delay applied by the zone controller 133 to allow for a long link delay to a target BS in every call set up would be very unsatisfactory to users.

Following the delay applied in step 209, the delayed call grant message is sent by the zone controller 133 and in a step 210 is received (via the link 135, the router 102 and the link 104) and is relayed by the sending BS 105. Following receipt of the delayed call grant message relayed in step 210, the sending MS 105 begins the call, i.e. begins sending traffic information, in a step 211.

In order for the traffic information sent by the sending MS 105 to reach the target terminals, including the MSs 115 and 125, a multicast tree has to be established to allow delivery of traffic information to take place between the sending MS 105 and the target terminals by multicast transmission. Establishment and operation of the required multicast tree is the responsibility of the router network of the system 100. As noted earlier, such routers include the router 102 which is to serve as an originating router, and the routers 112 and 122 which are to serve as target routers, together with any (core) routers (not shown) present in the network 131 between the originating router 102 and the target routers including the routers 112 and 122. The multicast tree may be established in one of several known ways, each using a different protocol. Examples of such ways include the following known alternatives:

(i) In a first alternative, a ‘Flood and Prune’ protocol may be used. In use of such a protocol, the router network in the system 100 is flooded with the multicast traffic signal sent by the originating router when the originating router first sends such a signal. Routers which do not need this signal, because they have not been informed that they are serving any target BS or a path to such a target BS, send back a ‘prune’ message which causes the tree required for delivery of the traffic signals to be suitably pruned by exclusion of such routers.
(ii) In a second alternative, a ‘Sparse Mode’ (‘SM’) protocol may be used. In use of this protocol, each multicast group may have an associated ‘rendezvous point’, which comprises a router of the router network, which serves as a point of co-ordination during multicast tree establishment. The rendezvous point could be the originating router, one of the target routers or a router elsewhere in the router network. Thus, each router of the router network can be configured as a rendezvous point for any one or more multicast groups to be established in the router network. Each multicast group may be identified by a multicast group IP address. When transmission of a traffic signal by the originating router begins, the signal is sent initially by the originating router to the rendezvous point. The traffic information is then distributed by the rendezvous point to the target routers. Routers in the path between the rendezvous point and the target routers are able to identify the originating router and the path required to the target routers. Such routers in the path may then send a message to other routers in the router network to indicate the required path. Other routers that are not in such a required path, which include routers that have not been informed that they are serving any target BS or a path to such a target BS, can thereby determine that they can be excluded from the multicast tree. Such routers send back a ‘prune’ message which causes the tree required for delivery of the traffic signals to be suitably pruned by exclusion of such routers in order to form a more optimal multicast tree (a ‘shortest path’ tree).

In a step 213 of the method 200, which takes place at the same time as step 205 (or immediately before or after step 205), the zone controller 133 sends an instruction message, herein referred to as a prompt message, to each of the target routers, to join a required multicast tree to enable delivery of the traffic information from the sending MS to each target MS or other target terminal, e.g. a dispatcher terminal or a traffic information recorder. As noted earlier, the target routers include routers associated with BSs which are serving target terminals to take part in the call, e.g. the router 112 and the router 122. The prompt message sent by the zone controller 133 in step 213 may be in the form of an IP compatible standard message understood by the relevant routers. For example, it may be a standard ‘IGMP (Internet Group Management Protocol) Join’ message. This definition includes (i) an ‘IGMP Join Group Request’ as defined in IGMP version 0, RFC 988 (specified by the Internet Engineering Task Force/Internet Engineering Steering Group); and (ii) an ‘IGMP Membership Report’ as defined in IGMP version 1, RFC 1112 and subsequently referred to in IGMP version 2, RFC 2236 and IGMP Version 3, RFC 3376); depending on the particular protocol version employed. In response, the target routers receiving the prompt message, including the routers 112 and 122, send in a step 215 a join response message to the router network. The join response message indicates that each target router is to be included in a required multicast tree. The join response message sent in step 215 may be sent in the form of an IP compatible standard message understood by the router network. For example, where the system 100 is operating using a Sparse Mode protocol, the join response message may be a standard ‘PIM-SM (Protocol Independent Multicast—Sparse Mode) Join’ message. In a step 217, the router network establishes a required multicast tree from the originating router 102 to the target routers using the response messages sent in step 215 to identify target routers that need to be included in the multicast tree. This establishment is done in one of the known ways described earlier. For example, where a Sparse Mode protocol is used, each join response message in the form of a PIM-SM message may be signalled through the router network until it arrives at the rendezvous point. The rendezvous point then participates in establishing the required multicast tree in the manner described earlier for Sparse Mode operation.

When the multicast tree has been established by the router network in step 217, traffic information sent from the sending MS 105, via the link 109, the BS 101 and the link 104, can be delivered via the multicast tree. Thus, the traffic information is delivered by the originating router 102, via the link 132, the network 131 and the links 134 and 136, to the target routers 112 and 122. The traffic information is further delivered from the router 112 via the link 114, the BS 111 and the radio link 119 to the target MS 115 and from the router 122 via the link 124, the BS 121 and the radio link 129 to the target MS 125. Thus, the target MSs 115 and 125 are able to receive the traffic information sent by the sending MS 105 in the call begun in step 211 when step 217 has been completed. The traffic information may be sent as multicast data packets in accordance with IP procedures, and the originating router 102 may use a single IP address as a header in the data packets to identify the multicast tree which has been established and is to deliver the traffic information.

The system 100 can be easily designed so that step 217 takes place no later than step 211. Thus, beneficially, no traffic information transmitted by the sending MS 105 is lost at the target receiving MSs 115 and 125. This is achieved essentially by the introduction of step 213 in the method 200 to allow the required multicast tree to become established as early as possible in the method 200. The routers 112 and 122 are instructed by the prompt message in step 213 to join the required multicast tree even though the associated BSs 111 and 121 may not have received by then the call grant message in step 207. Thus, step 213 can be considered as a ‘spoofed’ instruction message to target routers, including the routers 112 and 122, to join the multicast tree. Normally, such instructions are only sent as a host-to-router message, e.g. using a host-to-router message communication protocol in accordance with IP procedures.

Steps 219 to 223 indicated by dashed lines in FIG. 2 show how the required multicast tree would be established using known procedures. In a step 219, each of the target BSs 111 and 121, upon receiving the call grant message in step 207, sends a join message to notify its associated router that the associated router should join the required multicast tree. Thus, the BS 111 sends the join message to the router 112 and the BS 121 sends the join message to the router 122. The join message in each case may be a standard ‘IGMP Join’ message referred to earlier. In a step 221, the routers 112 and 122 send a join response message, e.g. a standard PIM-SM message, to the router network that they need to join the required multicast tree. In a step 223, the router network, e.g. by use of a rendezvous point of the router network, establishes the required multicast tree.

Undesirably, step 223 may be completed only after a delay following the beginning of the call by the sending MS 105 in step 211. In particular, reaching step 223 may be delayed if there is a delay in the link 114 between the router 112 and the BS 111 and/or in the link 124 between the router 122 and the BS 121. For instance, one or both of the links 114 and 124 may be a satellite wireless link with a delay of about 300 milliseconds each way. Thus in the known procedure including steps 219 to 223, a significant undesirable delay can occur in forming the required multicast tree, especially because of delay in the link 114 to the BSs 111 and/or the link 124 to the BS 121. In contrast, by allowing the required multicast tree to be formed in steps 213 to 217 without involvement of the target BSs 111 and 121, i.e. by the zone controller 133 issuing the prompt message in step 213, the link delay is beneficially avoided. This allows the multicast tree to be established and traffic information to be delivered in the system 100 via the multicast tree without significant loss of any of the traffic information.

It is to be noted that where steps 213 to 217 are applied in the method 200, the known steps 219 to 223 may be applied in addition. The join message sent by target BSs in step 219 may be repeated periodically in the known use of the step 219, so it is normal for a target router to receive repeats of the join message, e.g. an IGMP Join message, from target BSs. This confirms to the target router that the target BSs sending the join message still require to receive the communication via the multicast tree.

1. A method of operation in a communication system including a plurality of hosts, a controller and a network of routers, the method including allocating, by the controller, resources for communications between hosts; routing, by the network of routers,
communications between the hosts; wherein the controller sending to target routers associated with target hosts which are to receive a communication from a sending host a prompt message prompting the target routers to form a multicast tree via which the communication is to be deliverable.

2. A method according to claim 1 wherein at least one of the hosts comprises a base station serving a plurality of user terminals by wireless communication.

3. A method according to claim 2 wherein the sending host comprises a sending base station which is to send a communication on behalf of a sending user terminal and the target hosts comprise target base stations each of which is to receive the communication and to deliver the communication to at least one target user terminal served by the target base station.

4. A method according to claim 3 wherein the user terminals comprise mobile stations.

5. A method according to claim 4 wherein the controller is operable to allocate wireless channel resources for communications between user terminals.

6. A method according to claim 1 wherein, following receipt of the prompt message from the controller, each of the target routers sends in response a join response message to the network of routers to form a multicast tree between an originating router associated with a sending host, and target routers associated with target hosts which are to receive the communication.

7. A method according to claim 6 wherein the network of routers establishes, in response to receiving join messages from the target routers, a multicast tree for delivery of the communication from an originating router to target routers.

8. A method according to claim 7 wherein a rendezvous point of the network of routers participates in the establishment of the multicast tree.

9. A method according to claim 8 wherein an originating router receives from the sending host the communication to be delivered to the target hosts of the group and delivers the communication via the multicast tree which has been established.

10. A method according to claim 9 wherein the sending host comprises a base station serving a plurality of user terminals by wireless communication and one of the user terminals sends to the controller via its serving base station a request to make the communication to a designated group of target user terminals served by other base stations and in response the controller allocates wireless channel resource for the communication.

11. A method according to claim 10 wherein the controller sends to base stations which serve target user terminals which are to receive the communication a call grant message indicating a wireless channel resource available for the communication and the base stations deliver the call grant message to the user terminals, wherein the prompt message and the call grant message are sent substantially simultaneously by the controller.

12. A method according to claim 11 wherein the controller applies, after receiving the call request, a delay before it sends a call grant message to the sending user terminal and the sending user terminal begins the communication to be delivered when it has received the delayed call grant message.

13. A method according to claim 12 wherein the multicast tree is established not substantially later than the beginning of the communication to be delivered by the sending user terminal.
